(19) United States
(12) Patent Application Publication
(10) Pub. No.: US 2016/0212680 A1
(43) Pub. Date: Jul. 21, 2016

(54) RAPID REROUTING IN A COMMUNICATION SYSTEM

(71) Applicant: NOKIA SOLUTIONS AND NETWORKS OY, Espoo (FI)

(72) Inventors: Anup TALUKDAR, Schaumburg, IL (US); Mark CUDAK, Rolling Meadows, IL (US); Amitabha GHOSH, Buffalo Grove, IL (US); Rapeepat RATASUK, Hoffman Estates, IL (US); Jun TAN, Lake Zurich, IL (US); Timothy THOMAS, Palatine, IL (US); Frederick VOOK, Schaumburg, IL (US)

(21) Appl. No.: 14/597,987

(22) Filed: Jan. 15, 2015

(51) Int. Cl. H04W 40/12; H04W 40/36; H04W 72/04

(52) U.S. Cl. CPC H04W 40/12; H04W 72/042; H04W 40/36; H04W 36/30

(57) ABSTRACT

Various communication systems may benefit from rerouting considerations. For example, fifth generation (5G) systems dealing with radio link failure detection and data rerouting, particularly mmWave 5G systems, may benefit from rapid rerouting methods and systems. A method can include transmitting, from an access point, a downlink control message to a user equipment. The method can also include attempting to detect a Fast-ACK transmission signal from the user equipment in response to the transmitted downlink control message. The method can further include transmitting a rerouting request for the user equipment when the Fast-ACK transmission signal is not detected.

### BACKGROUND

1. Field

Various communication systems may benefit from rerouting considerations. For example, fifth generation (5G) systems dealing with radio link failure detection and data rerouting, particularly mmWave 5G systems, may benefit from rapid rerouting methods and systems.

2. Description of the Related Art

5th Generation wireless networks are being designed to deliver peak data rates of the order of about ten gigabits per section (Gbps). Target latency requirements have been set to the order of about one msec in order to serve applications with ultra-low latency performance requirements. Millimeter wave (mmWave) frequency bands have been identified as a promising candidate for 5th generation (5G) cellular technology.

Spectrum in traditional cellular bands, below six gigahertz (GHz), is finite. As cellular data traffic demand continues to grow, new frequency bands may need to be considered. Unlike traditional cellular bands, large blocks of contiguous spectrum may be allocated at millimeter wave (mmWave) bands, allowing for bandwidths on the order of about a GHz or more.

Moreover, the mmWave bands allow for multi-element antenna arrays composed of very small elements, on the order of integrated circuit (IC) chip scales, providing large antenna gain and sufficient power output through over-the-air power combining. This combination of large bandwidths and device architectures may allow mmWave cellular to provide peak rates on the order of about ten Gbps and ample capacity to meet future demands.

The propagation characteristics in the mmWave band are more challenging than traditional cellular. Diffraction at mmWave bands is effectively non-existent and propagation behaves similar to visible light. Transmission through most objects is diminished, thus foliage and other common obstacles can produce severe shadowing. On the other hand, reflective power is improved, offering new opportunities for completing the link, but reflected signals may be 15 dB-40 dB weaker than the original signal.

In a typical urban deployment, mmWave access points (APs) are expected to be installed on top of street-side poles, possibly at street corners; other deployment scenarios are stadiums, college campus courtyards, tourist hotspots.

The severe shadowing loss characteristics in the mmWave band imply that the radio link between a user equipment (UE) and the UE's serving AP will be disrupted if the line of sight (LOS) is blocked by obstacles. For a pedestrian walking along the sidewalk in a city block, the UE's LOS may be blocked by fixed obstacles, such as trees, or moving obstacles, such as large trucks or other pedestrians. In a campus courtyard or a tourist hotspot LOS blocking may be caused by crowds. Other types of LOS blocking may be caused by user motions such as hand or body rotations. In order to deliver reliable connectivity to a user in presence of obstacles, a mmWave access point network may be built with enough redundancies of APs such that in the event of a LOS blocking, the network connection of the UE can be rapidly rerouted via another AP. In such a network, a cluster of access points can coordinate to provide uninterrupted connectivity to a UE overcoming radio link blockages due to obstacles.

Each UE in a mmWave network can be served by a cluster of APs, called its cluster set. Members of the cluster set of a UE can be selected based on the accessibility of the APs from the UE. Among the APs in the cluster set, one particular AP can be selected as the serving AP for the UE. The network can communicate with the UE through the serving AP. However, the UE can maintain continuous connectivity with each member of the cluster set by maintaining synchronization with the symbol and frame structure, downlink and uplink control channels. As part of this synchronization, the UE knows the symbol timing the starting time of the radio frame and its duration, the timings of the synchronization channel, downlink control channel and uplink control channel. In this embodiment, synchronization may further imply that the UE is not only aware of the individual frame timing of each AP in the cluster set but is also aware of the best accessibility information. The accessibility information between an AP and a UE may consist of the best transmit and receive antenna weights associated with the best beam, the antenna polarization (e.g. horizontal, vertical or circular) and the corresponding signal strengths. The best transmit and receive antenna weights would determine the antenna directivity for a multi-element antenna array. For more discussion, see M. Cudak, A. Ghosh, T. Kovarik, R. Ratasuk, T. Thomas, F. Vook, P. Moorut, “Moving Towards mmWave-Based Beyond-4G (B-4G) Technology,” in Proc. IEEE VTC-Spring 2013, Jun. 2-5, 2013, which is hereby incorporated herein by reference in its entirety.

The antenna weights can be implemented using either an analog, digital or hybrid implementation. Other implementations of directional antennas could also be supported by this invention. For example, a di-electric lens antenna can focus mmWave energy through diffraction similar to how an optical lens focuses light. The antenna directivity of a di-electric lens antenna is controlled by configuring the switching feed elements. For more discussion, see M. Cudak, T. Kovarik, T. Thomas, A. Ghosh, Y. Kishiyama, T. Nakamura, “Experimental mmWave 5G Cellular System” (2014).

FIG. 1 illustrates a cluster set of a user equipment and the user equipment's cluster set manager (CSM). The cluster set of a UE can be configured and managed by the CSM. For example, there can be a logical instance of CSM for each UE that is located in the network. The location of the CSM can be close to the APs in the cluster set to enable low-latency communication with those APs and the UE. In FIG. 1, a cluster set containing three APs and a cluster set manager (CSM) are shown for a user equipment. Adjacent APs are shown connected to each other by interface X5, with the AP having the CSM being connected to a core network.

FIG. 2 illustrates a mmWave 5G frame structure. More particularly, an air-interface frame structure proposed for a mmWave 5G system is shown in FIG. 2. In this structure a 20 msec superframe is subdivided into 40 subframes each of duration 500 microsec. Each subframe is further divided into 5 slots of 100 microsec duration. A slot can be synchronization slot (a.k.a synchronization channel), uplink random access channel (RACH) slot or a data slot.

An access point may transmit its synchronization signal over its synchronization slot. The synchronization signal may be used by a UE for performing system acquisition and also for performing a UE-specific beam synchronization to attain the accessibility information for the particular antenna configuration. The synchronization channel is transmitted every 20 msec. The RACH slot can be used by a UE to send an uplink resource request and additionally it can also be used by the UEs to provide feedback on beam selection. A data slot contains three segments, downlink control, uplink control and data. The downlink control region is used to communicate the downlink/uplink resource allocations and may also be used to send commands to configure the user equipment. The uplink control region can be used for sending ARQ ACK/NACK for downlink data transmissions, channel state information feedback, and/or uplink polling to request uplink resource.

The data segment can be used for either downlink or uplink data transmission as part of the dynamic time division duplex (TDD) feature and is determined by the resource allocation in the downlink control channel. For high efficiency, communications over the downlink control region, the uplink control region and the data segment uses user-specific beamforming.

### SUMMARY

According to certain embodiments, a method can include transmitting, from an access point, a downlink control message to a user equipment. The method can also include attempting to detect a Fast-ACK transmission signal from the user equipment in response to the transmitted downlink control message. The method can further include transmitting a rerouting request for the user equipment when the Fast-ACK transmission signal is not detected.

In certain embodiments, a method can include receiving, at a user equipment from an access point, a downlink control message over a downlink control channel. The method can also include replying to the downlink control message with a Fast-ACK transmission signal over a Fast-ACK channel.

A method, according to certain embodiments, can include receiving, from an access point, a rerouting request for a user equipment. The method can also include sending, to an alternate access point, a rerouting command responsive to the rerouting request for the user equipment.

A method, in certain embodiments, can include receiving a rerouting command, intended for a user equipment, at an access point. The method can also include the access point subsequently transmitting a handoff command to the intended user equipment. The rerouting command may also include downlink or uplink resource allocation or any other command to the user equipment. The rerouting command may also specify the downlink control channel to be used by the access point for transmission of downlink control messages to the user equipment. The handoff command may include the corresponding downlink or uplink resource allocation or other command which was included in the rerouting command. The handoff command may be transmitted over the downlink control channel specified in the rerouting command.

An apparatus, in certain embodiments, can include at least one processor and at least one memory including computer program code. The at least one memory and computer program code can be configured to, with the at least one processor, cause the apparatus at least to transmit, from an access point, a downlink control message to a user equipment. The at least one memory and computer program code can also be configured to, with the at least one processor, cause the apparatus at least to attempt to detect a Fast-ACK transmission signal from the user equipment in response to the transmitted downlink control message. The at least one memory and computer program code can further be configured to, with the at least one processor, cause the apparatus at least to transmit a rerouting request for the user equipment when the Fast-ACK transmission signal is not detected.

According to certain embodiments, an apparatus can include at least one processor and at least one memory including computer program code. The at least one memory and computer program code can be configured to, with the at least one processor, cause the apparatus at least to receive, at a user equipment from an access point, a downlink control message over a downlink control channel. The at least one memory and computer program code can also be configured to, with the at least one processor, cause the apparatus at least to reply to the downlink control message with a Fast-ACK transmission signal over a Fast-ACK channel.

In certain embodiments, an apparatus can include at least one processor and at least one memory including computer program code. The at least one memory and computer program code can be configured to, with the at least one processor, cause the apparatus at least to receive, from an access point, a rerouting request for a user equipment. The at least one memory and computer program code can also be configured to, with the at least one processor, cause the apparatus at least to send, to an alternate access point, a rerouting command responsive to the rerouting request for the user equipment.

An apparatus, in certain embodiments, can include at least one processor and at least one memory including computer program code. The at least one memory and computer program code can be configured to, with the at least one processor, cause the apparatus at least to receive a rerouting command, intended for a user equipment, at an access point, and subsequently transmitting a handoff command to the user equipment.

An apparatus, according to certain embodiments, can include means for transmitting, from an access point, a downlink control message to a user equipment. The apparatus can also include means for attempting to detect a Fast-ACK transmission signal from the user equipment in response to the transmitted downlink control message. The apparatus can further include means for transmitting a rerouting request for the user equipment when the Fast-ACK transmission signal is not detected.

An apparatus, in certain embodiments, can include means for receiving, at a user equipment from an access point, a downlink control message over a downlink control channel. The apparatus can also include means for replying to the downlink control message with a Fast-ACK transmission signal over a Fast-ACK channel.

According to certain embodiments, an apparatus can include means for receiving, from an access point, a rerouting request for a user equipment. The apparatus can also include means for sending, to an alternate access point, a rerouting command responsive to the rerouting request for the user equipment.

An apparatus, in certain embodiments, can include means for receiving a rerouting command, intended for a user equipment, at an access point. The apparatus can also include means for subsequently transmitting a handoff command to the intended user equipment.

In certain embodiments, a non-transitory computer-readable medium can be encoded with instructions that, when executed in hardware, perform a process. The process can be any of the above-described methods.

A computer program product can, according to certain embodiments, encode instructions for performing a process. The process can be any of the above-described methods.

### BRIEF DESCRIPTION OF THE DRAWINGS

For proper understanding of the invention, reference should be made to the accompanying drawings, wherein:

FIG. 1 illustrates a cluster set of a user equipment and the user equipment's cluster set manager (CSM).

FIG. 2 illustrates a mmWave 5G frame structure.

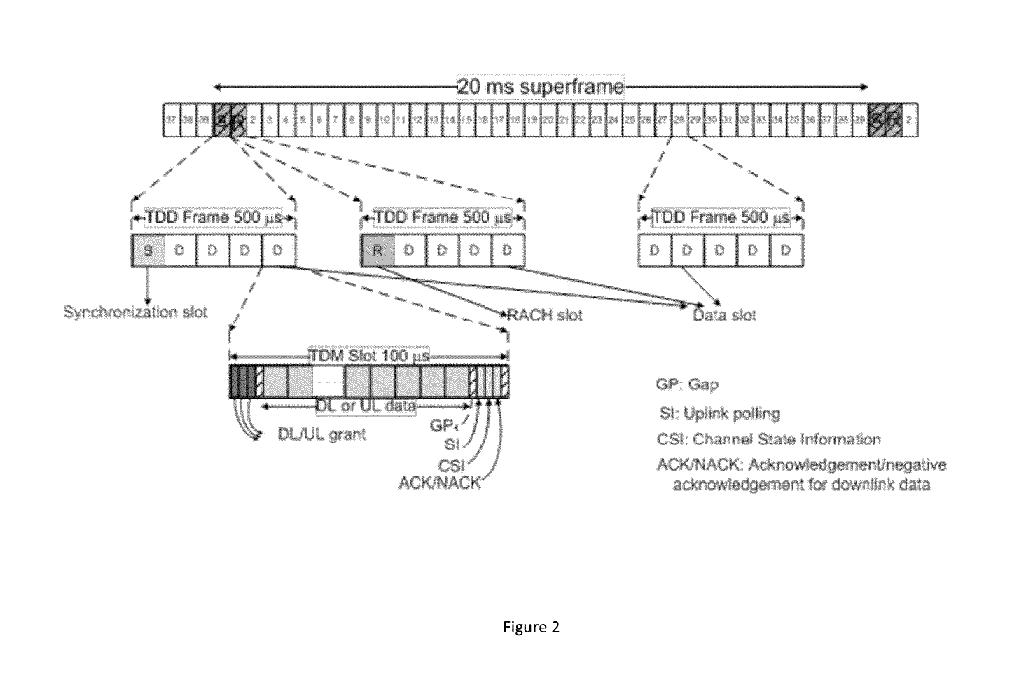

FIG. 3 illustrates radio link blockage detection during downlink data transfer, according to certain embodiments.

FIG. 4 illustrates radio link blockage detection during uplink data transfer, according to certain embodiments.

FIG. 5 illustrates fast link blockage detection by an access point during downlink data transfer, according to certain embodiments.

FIG. 6 illustrates fast link blockage detection by an access point during uplink data transfer, according to certain embodiments.

FIG. 7 illustrates rapid rerouting during downlink data transfer, according to certain embodiments.

FIG. 8 illustrates rapid rerouting during uplink data transfer, according to certain embodiments.

FIG. 9 illustrates monitoring the downlink control channel of multiple access points for rapid rerouting, according to certain embodiments.

FIG. 10 illustrates a method according to certain embodiments.

FIG. 11 illustrates a system according to certain embodiments.

### DETAILED DESCRIPTION

As explained above, in order to meet the ultra-low latency requirements of a 5G wireless network, radio link blockages may need to be detected very fast and with high reliability. The use of user-specific dedicated beamforming for control and data channels in mmWave 5G communication between a UE and its serving AP may pose a significant challenge to the radio link blockage detection.

For example, a UE may only be able to detect a transmission from the AP when the transmission is scheduled: link blockage and un-scheduled events may thus be indistinguishable to a UE. Also, the conventional methods of detecting radio link failure/degradation by measurements of the radio link over a sufficiently long interval are inherently unsuitable to meet the about one millisecond latency requirement of 5G. Therefore, certain embodiments may provide a method for fast detection of link blockage and rapid rerouting that can meet the 5G latency requirements in a mmWave access network.

In certain embodiments, an access node can detect a link failure by using DTX detection for UL and DL scenarios on a “Fast-ACK” channel. When an access point transmits a downlink control message to an UE, the access point can also allocate a Fast-ACK channel for the UE to respond with a Fast-ACK signal on successfully receiving the downlink control message. Thus a DTX detection on the Fast-ACK channel indicates a radio link failure. Alternatively, an access point may determine that the link has failed if multiple attempts to send the downlink control message fails. Other methods of radio link blockage failure detection can also be used, such as DTX detection on the AC/NACK channel for downlink data transfer scenario, and DTX detection on the data channel in the uplink data transfer scenario. Once the link failure is detected, the access point can transmit a data reroute request to a network manager. The network manager can then select the appropriate access point for rerouting and can send the appropriate commands. In order for this mechanism to work, a UE may also need to monitor not only the downlink control channel of its serving access point, but also the downlink control channel of one or more alternate access points from a predefined set.

Radio link failure (RLF) can be determined by a node, such as a UE or an AP, by detection of the absence of transmission signal, which the node expected to receive as part of the communication protocol. This mechanism of radio link failure can be referred to as discontinuous transmission (DTX) detection. The communication protocol may depend on the type of data transfer, for example downlink (DL) or uplink (UL). In the following, first the link blockage detection entities for downlink and uplink data transfers are discussed. Then methods for link blockage detection and rapid rerouting during downlink and uplink data transfers are described.

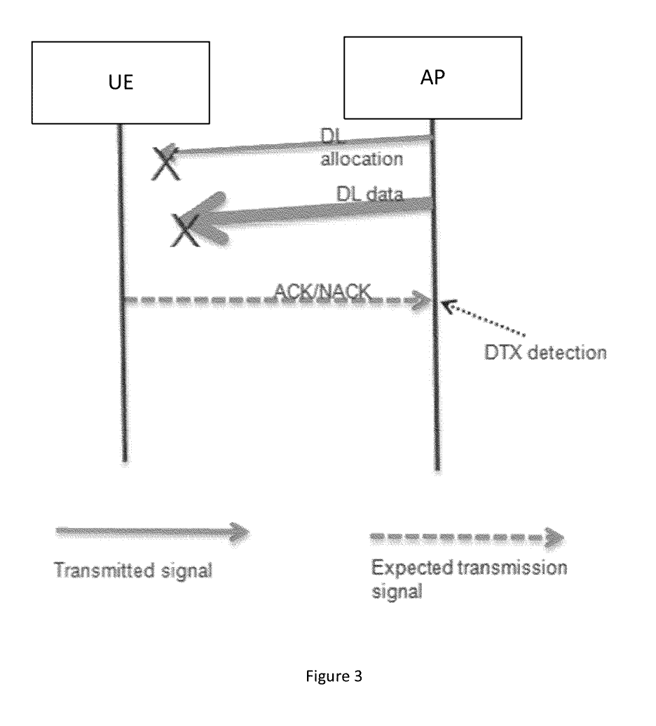

FIG. 3 illustrates radio link blockage detection during downlink data transfer, according to certain embodiments. More particularly, FIG. 3 illustrates an example, for the proposed mmWave 5G air interface, of a typical downlink data transfer protocol over the radio link.

In this protocol, the UE can monitor the DL control channel of the UE's serving AP for its downlink radio resource allocation. If the radio link is blocked when the AP transmits the downlink allocation to the UE, the UE can fail to successfully decode the DL control channel and can interpret this event as if the AP never scheduled any transmission to it. Thus the UE may be unaware of the AP's attempt to transfer downlink data. This implies that during downlink data transfer, the UE may not be in a favorable position to detect radio link blockages. However, the AP can declare the link is blocked based on DTX detection in the ACK/NACK channel.

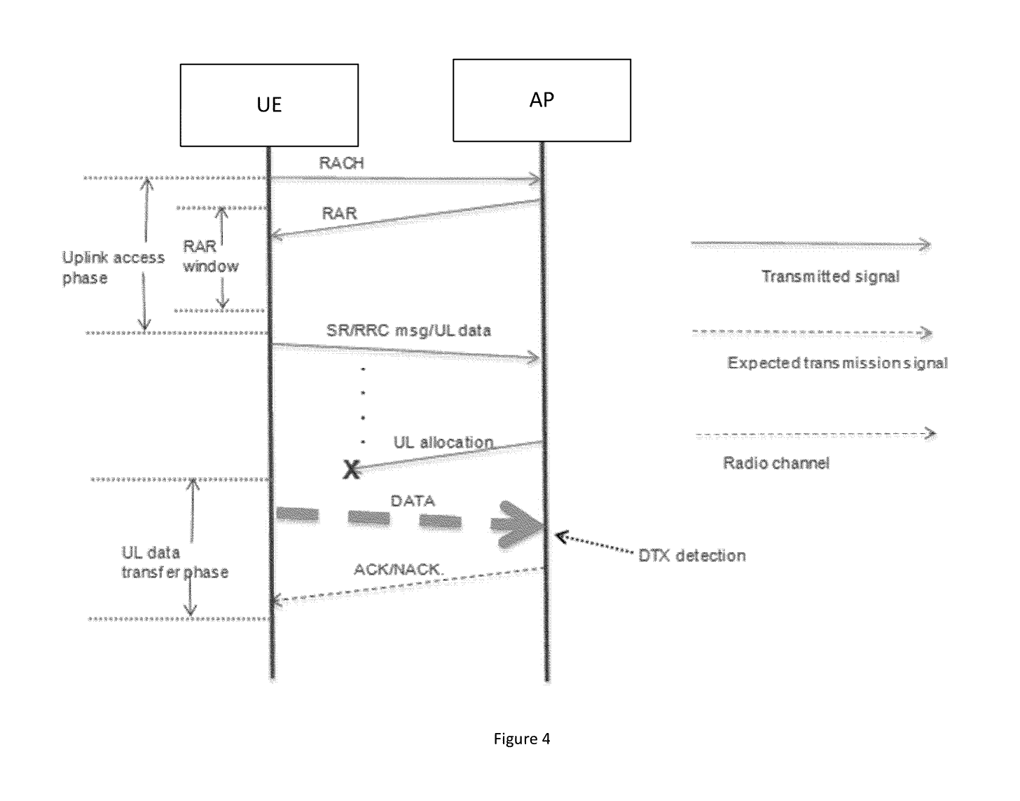

FIG. 4 illustrates radio link blockage detection during uplink data transfer, according to certain embodiments. There can be two phases in the uplink data transfer: uplink access phase and data transfer phase. The UE can enter the uplink access phase after a period of inactivity. In the access phase, the UE can send a request for UL resource allocation. In the data transfer phase, the serving AP can allocate UL resources over which the UE can transmit data packets. The timing of the data transfer phase can be determined by the scheduler. These two phases are illustrated in FIG. 4. The radio link blockage detection and rapid rerouting procedures during uplink access phase can be accomplished in any way desired.

Certain embodiments can address radio link blockage detection and rapid rerouting during the data transfer phase. Similar to the downlink data transfer scenario, the UE may not be in a favorable position to detect the radio link blockages in the data transfer phase, because the UE may interpret a failure to decode the UL resource allocation message over the beamformed DL control channel as if the serving AP has not scheduled any message. However, the AP can detect the blockage by DTX detection in the UL data channel.

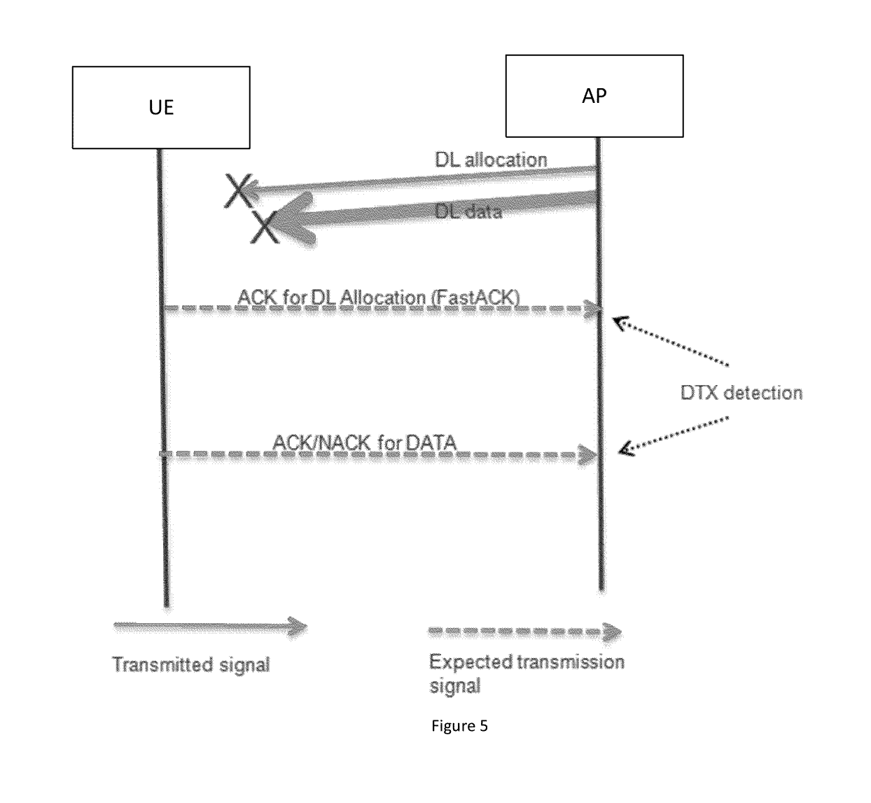

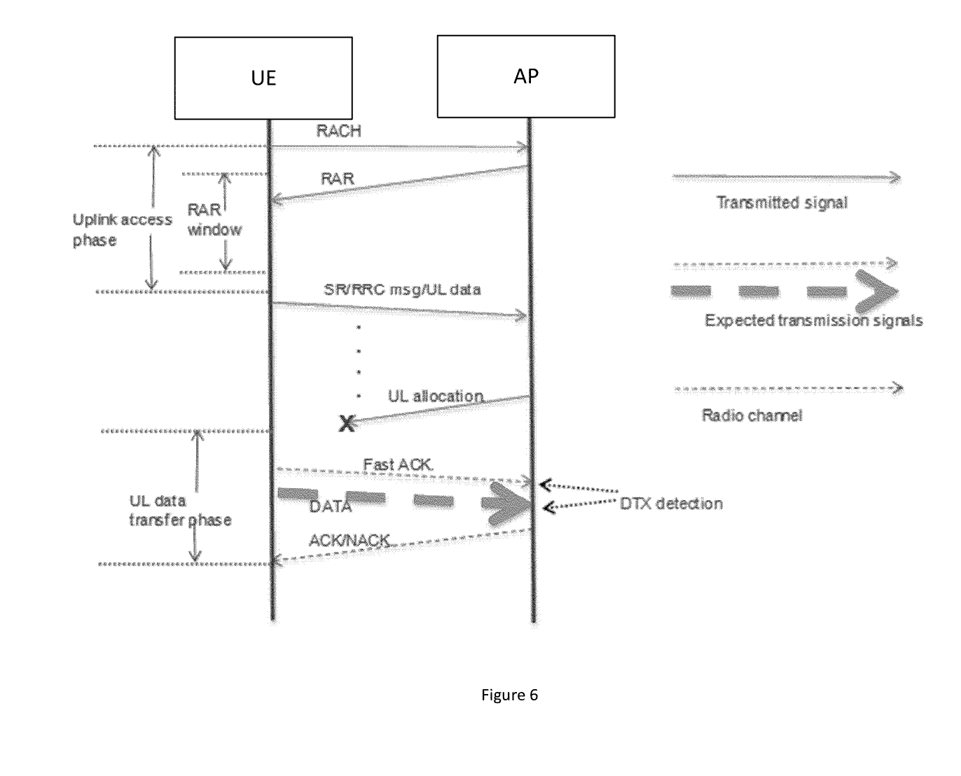

FIG. 5 illustrates fast link blockage detection by an access point during downlink data transfer, according to certain embodiments. Similarly, FIG. 6 illustrates fast link blockage detection by an access point during uplink data transfer, according to certain embodiments. The link blockage detection latency for the downlink data transfers as described in FIG. 3 may depend on several factors: the delay between the DL allocation message and the DL data transmission, DL data decoding time at the UE, and the ACK/NACK transmission delay. For the UL data transfer as showed in FIG. 4, the link blockage detection latency may be determined by the delay between the UL allocation message and the UL data transmission. These delays may impose a significant challenge to complete the rapid rerouting within a 1 msec latency budget with high reliability.

As shown in FIG. 5, the link blockage detection latency can be reduced by introducing a Fast-ACK channel for the downlink control messages, whereby the UE, on successful detection of a downlink control channel message, can send a Fast-ACK signal to the AP. Since DL control message decoding can be accomplished much faster, for example within the slot duration of 0.1 msec, Fast-ACK can be scheduled much earlier than the ACK/NACK channel for the downlink data. Similarly, as shown in FIG. 6 for uplink data transfer, Fast-ACK corresponding to the UL resource allocation message can also be scheduled within one slot duration of 0.1 msec.

Fast-ACK may also contain some additional information about the link quality in addition to the implicit confirmation that the downlink control message was received. The additional information can include, for example, signal to interference plus noise ratio (SINR), channel state information (CSI), preferred beam, preferred AP or AP measurement reports, rank-ordered list of alternate APs, the best beam of the best alternate AP, and the like. This feedback can help the serving AP track link conditions at the UE, while involving more information being transmitted by the UE.

The serving AP's link quality information can also be measured from the DL data slot, instead of or in addition to the DL control slot, which can give the AP some information about whether the DL data transmission is likely to be decoded correctly. The use of the DL data slot may increase latency but may be acceptable if, for example, control is sent in slot n and data is sent in slot n or n+1.

The CSI contained in the Fast-ACK may include basis function feedback for alternate APs, or the single best basis function to an alternate AP. Basis function feedback can refer to a method in which the AP sounds orthogonal beams and the UE determines and feeds back a gain and phase value for the dominant or strongest beams. The use of basis function beams can provide the AP with full channel information to each antenna, as opposed to just the best beam, and hence can provide more accurate beamforming. By adding basis function feedback to the alternate APs in the Fast-ACK, the alternate AP may be informed about the channel condition between the alternate AP and the UE, including how best to point the alternate AP's beam.

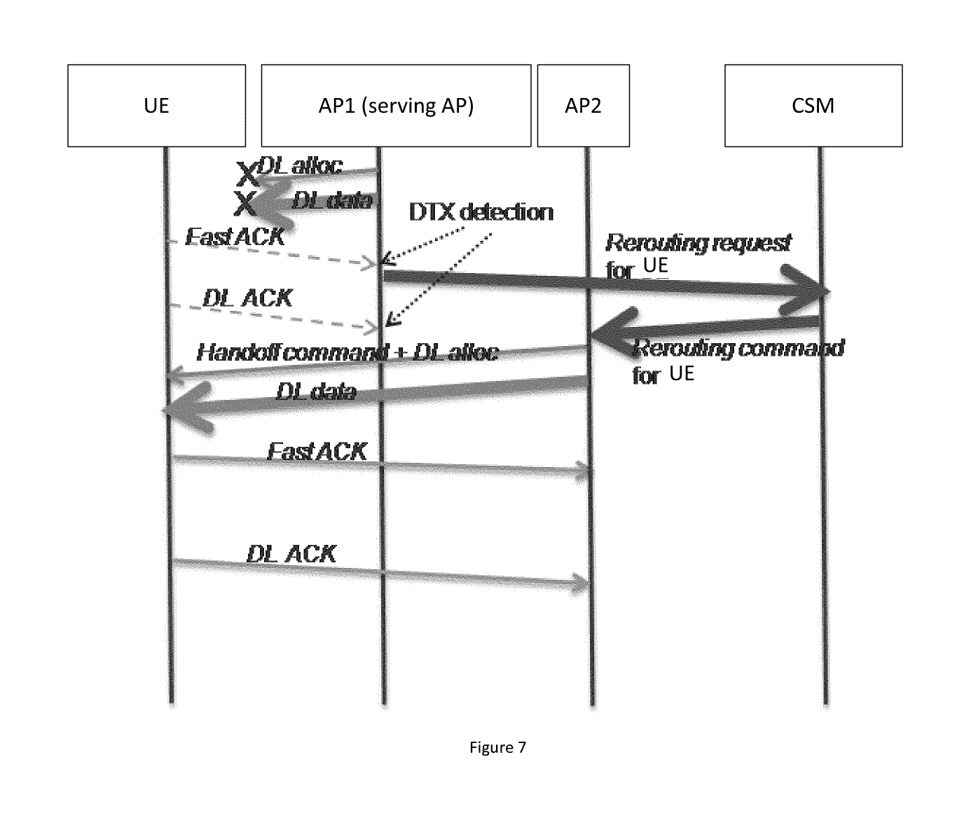

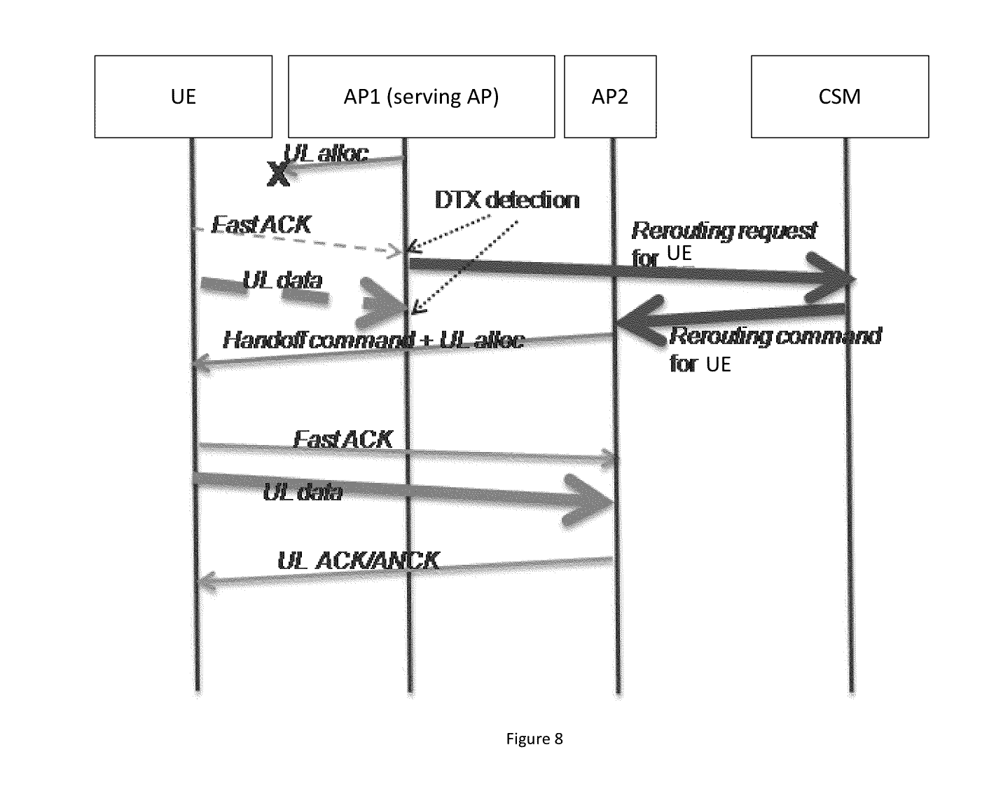

FIG. 7 illustrates rapid rerouting during downlink data transfer, according to certain embodiments. Similarly, FIG. 8 illustrates rapid rerouting during uplink data transfer, according to certain embodiments. After the serving AP detects the link blockage, a radio link may need to be established between the UE and an alternate AP, which can become the new serving AP. This rerouting can be accomplished by, for example, the rapid rerouting procedure as shown in FIG. 7 and FIG. 8 for DL and UL data transfers, respectively.

On detection of the radio link blockage, the serving AP (for example, AP1 in FIGS. 7 and 8) can send a rerouting request for the UE to the UE's CSM. The CSM can then send a rerouting command to an alternate AP (for example, AP2 in FIGS. 7 and 8) in the cluster set of the UE. In addition, the CSM can also begin forwarding DL data packets for UE to AP2. On receiving the rerouting command, AP2 can send a handoff command to the UE. In the DL transfer scenario, AP2 may also send a DL allocation message followed by DL data transmission, whereas in the uplink data transfer scenario, AP2 may also send an UL allocation for the UE. On receiving the handoff command, the UE can determine that the UE's radio link to AP1 is blocked and may designate AP2 as the UE's new serving AP and configure the UE's transmitter/receiver beams to communicate with AP2.

In the rerouting request that the AP1 sends to the CSM, the request may contain additional information that may help the AP2 to set up the link to the UE. The additional information may include, for example, link quality information such as SINR between AP2 and the UE, the best beam for AP2, and/or channel state information (CSI) which AP2 could use to determine AP2's beamforming weights. Then the CSM may transmit this information to AP2 in the rerouting command for the UE.

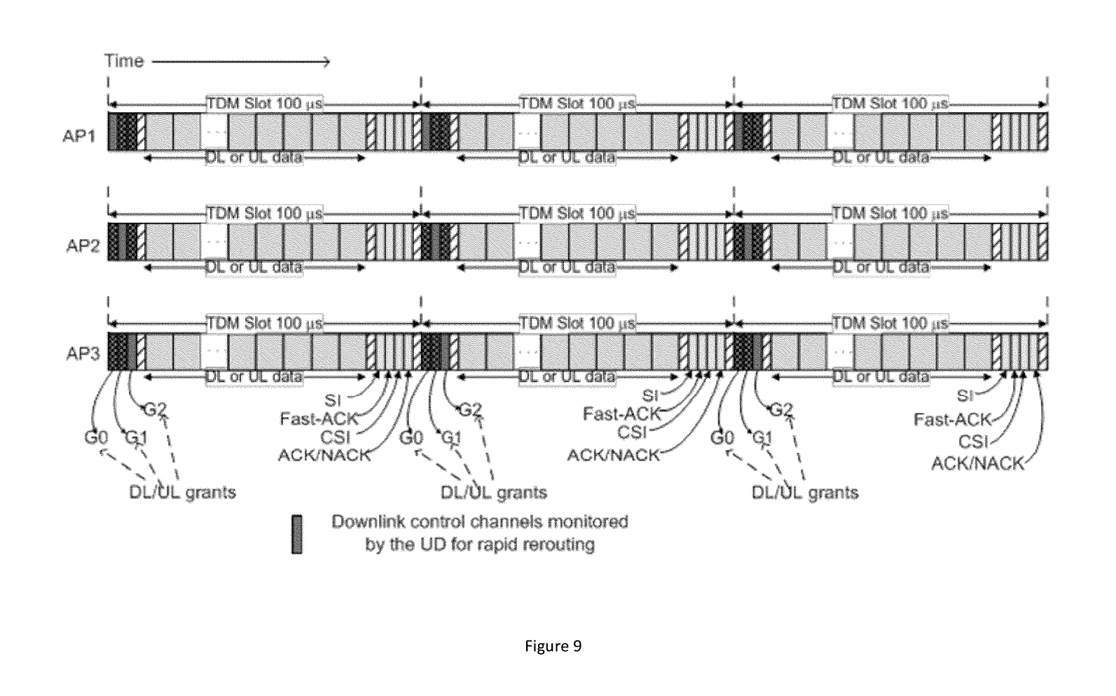

FIG. 9 illustrates monitoring the downlink control channel of multiple access points for rapid rerouting, according to certain embodiments. In the above procedure for link blockage detection, the UE may monitor the downlink control channel of not only the UE's serving AP, but one or more alternate APs in the UE's cluster set. An example downlink control channel structure for monitoring multiple APs in a mmWave air-interface radio subframe is shown in FIG. 9.

In FIG. 9, the structure of the data slots are shown for access points, AP1, AP2 and AP3, which are in the cluster set of a user equipment (UE). AP1 is the current serving AP for the UE, whereas AP2 and AP3 are the candidates for handover in the event of the radio link blockage between the UE and AP1. As shown, the downlink control region of the data slot can contain three channels G0, G1 and G2 which are time-division multiplexed. The UE can monitor the G0 of the UE's serving access point AP1 for downlink and uplink radio resource allocations or any other downlink control channel messages. In addition, the UE can also monitor G1 of AP2 and G2 of AP3 for rapid rerouting commands and downlink/uplink radio resource allocations or any other downlink control channel messages.

Alternately, only one control slot may be used. Since the slot may be managed by the CSM, there may not be contention in the slot, such as two APs trying to transmit to the same UE. In this case, the identity of the AP can be included in the control command for rapid rerouting or resource allocation. This alternative may be useful when the UE beamforms the downlink control channel reception in an omni-directional fashion. In such a case, the UE may not know toward which AP the UE should be pointing the UE's beam when trying to decode a control channel. If the UE listens with very directional beams tailored to each AP, then the first alternative may be beneficial, because the UE may know when to expect a transmission from each particular AP.

In complementary functions, AP1 can transmit downlink control messages to the UE over AP1's G0. When AP1 detects the radio link blockage to UE, AP1 can initiate the rapid rerouting procedure as described in FIG. 7 and FIG. 8. Access point AP2, on receiving the rerouting command for the UE, can transmit a handoff command along with DL/UL allocation over AP2's downlink control channel G1.

In the event of the radio link to AP2 also being blocked, rerouting to AP2 may be unsuccessful. AP2 can detect this blockage using the same link blockage detection method (or any other link blockage detection method) and can send a rerouting request for the UE to CSM. The rerouting request can indicate failure of the rerouting process from AP1 to AP2. On observing that rerouting to AP2 failed, CSM can send a rerouting command to AP3 for UE. AP3 can use AP3's downlink control channel G2 to execute the handover of the UE.

After the rerouting is completed and assuming AP2 is not blocked, AP2 may be designated as the UE's serving AP. Thus, the UE may monitor G0 of AP2. The UE's cluster set configuration may be reconfigured for rapid rerouting event monitoring purposes. Alternatively, UE may continue to be served by AP2 over G1 until AP1 is unblocked.

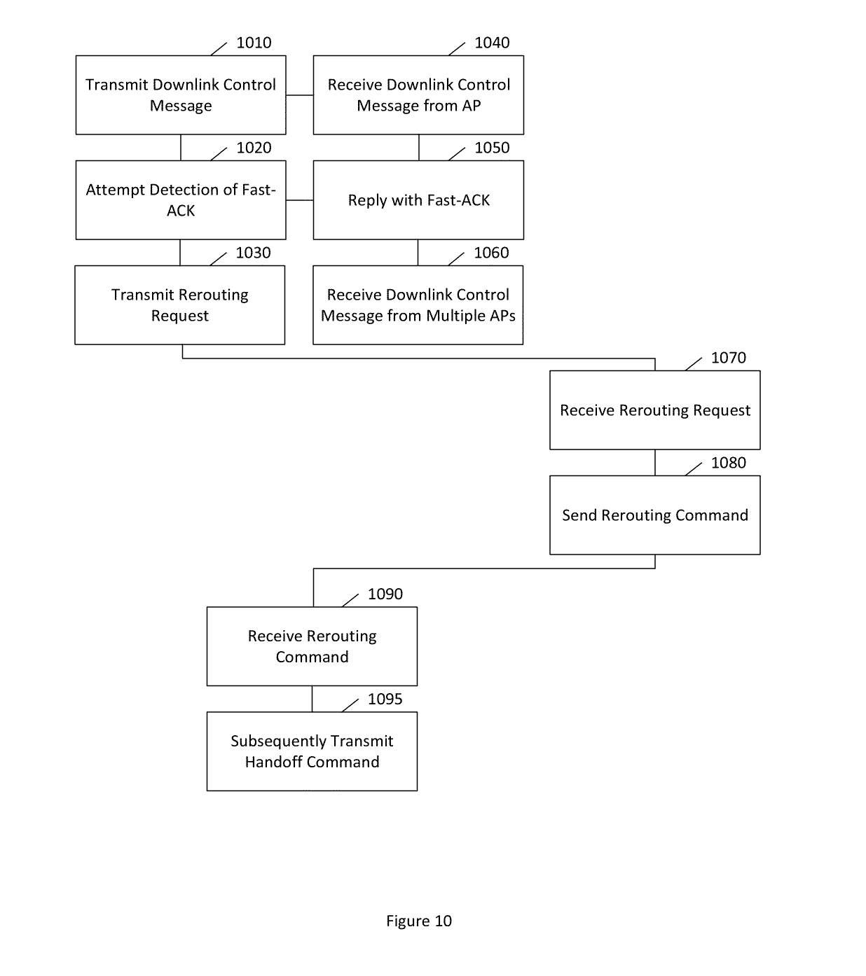

FIG. 10 illustrates a method according to certain embodiments. As shown in FIG. 10, a method can include, at 1010, transmitting, from an access point, a downlink control message to a user equipment. The downlink control message can be or include at least one of a downlink resource allocation message or a uplink resource allocation message.

The method can also include, at 1020, attempting to detect a Fast-ACK transmission signal from the user equipment in response to the transmitted downlink control message. The method can further include, at 1030, transmitting a rerouting request for the user equipment when the Fast-ACK transmission signal is not detected. The Fast-ACK transmission signal can include information about a radio link between the user equipment and an alternate access point. For example, the information can include link quality, best beam, and/or channel state information.

The transmitting the rerouting request can include transmitting the request to a cluster set manager (CSM) configured to control routing of messages to the user equipment. Thus, as mentioned above, there can be architecture in which the user equipment is served by a cluster of access points of which the access point transmitting at 1010 can be the current serving access point.

Both the transmitting the downlink control message and the attempting to detect the Fast-ACK transmission signal, or either of these, can involve using beamforming. Alternatively, these transmitting and attempting detection can be performed omni-directionally.

The above-described transmitting at 1010, attempting detection at 1020, and transmitting at 1030 can be performed by, for example, an access point. Thus, certain embodiments can relate to a method for transmitting a downlink control message to a user equipment, and subsequently attempting to detect a transmission signal, Fast-ACK, from the user equipment in response to the transmitted downlink control message, and transmitting a rerouting request to the Cluster Set Manager (CSM) if unsuccessful in detecting the Fast-ACK transmission signal.

The downlink control message can be a downlink resource allocation message or uplink resource allocation message, or any other control message. As mentioned above, the downlink control message transmission can be beamformed. Similarly, the Fast-ACK signal reception can be beamformed.

The rerouting request can include information about the radio link between an alternate access point and the user equipment, such as link quality (for example, SINR), the best beam, and/or channel state information (CSI). The alternate access point could use such information to determine the alternate access point's beamforming weights and any other transmission configuration parameters.

The method can also include, at 1040, receiving, at a user equipment from an access point, a downlink control message over a downlink control channel. This can be the same downlink control message sent at 1010, or another one sent at another time. As illustrated in FIG. 9, the process can be repetitive and cyclical.

As shown in FIG. 10, the method can also include, at 1050, replying to the downlink control message with a Fast-ACK transmission signal over a Fast-ACK channel. The replying can be contingent on successfully decoding the downlink control message.

Both the receiving the downlink control message and the replying with the Fast-ACK transmission signal, or either of these, can involve using beamforming.

The method can also include, at 1060, receiving a second downlink control channel from at least one other access point. Additional downlink control channels can also be received from other access points. The downlink control channel and the second downlink control channel can be time-multiplexed and can be received using beamformed receivers. Alternatively, the downlink control channel and the second downlink control channel can be received simultaneously using an omni-directional receiver. Here, “simultaneously” can refer to cases in which the control channels are received on a same radio frequency resource or in an overlapping time period. Exact simultaneity is not required.

As mentioned above, the Fast-ACK transmission signal can include information about a radio link between the user equipment and an alternate access point. The information can include at least one of signal to interference plus noise ratio, channel state information, preferred beam, preferred access point or access point measurement reports, rank-ordered list of alternative access points, or best beam of a best alternative access point.

The receiving at 1040, replying at 1050, and receiving at 1060 can be performed by a user equipment, which may be served by a cluster of access points managed by a cluster set manager. Thus, certain embodiments can provide a method for receiving a downlink control channel and transmitting a Fast-ACK signal over the Fast-ACK channel on successfully decoding a downlink control message over the downlink control channel. The downlink control reception can be beamformed. Similarly, the Fast-ACK transmission can be beamformed, as mentioned above.

The method can involve receiving the downlink control channels of multiple access points. The user equipment can receive the downlink control channels of the multiple access points in time multiplexed mode using beamformed receivers. Alternatively, or in addition, the user equipment can receive the downlink control channels of the multiple access points simultaneously using an omni-directional receiver.

The Fast-ACK transmission can include information about the link quality such as, SINR, CSI, preferred beam, preferred AP or AP measurement reports, rank-ordered list of alternate APs, and/or the best beam of the best alternate AP. The CSI may include basis function feedback for alternate APs, or the single best basis function to an alternate AP.

The method of FIG. 10 can also include, at 1070, receiving, from an access point, a rerouting request for a user equipment. The method can further include, at 1080, sending, to an alternate access point, a rerouting command responsive to the rerouting request for the user equipment.

The rerouting command can include information about a radio link between the user equipment and the alternate access point. For example, the information can include link quality, best beam, and/or channel state information. Furthermore, the rerouting command can be or include at least one of a downlink resource allocation message or an uplink resource allocation message or any other control message. The rerouting command may also include an identification of a downlink control channel of the alternate access point which will be used for transmitting the handoff command to the user equipment.

The receiving at 1070 and the sending at 1080 can be performed by a cluster set manager. Thus, for example, certain embodiments can provide a method for receiving a rerouting request for a user equipment, and subsequently sending a rerouting command for the user equipment to an alternate access point.

The rerouting request can include information about the radio link between an alternate access point and the user equipment, such as link quality (for example, SINR), the best beam, and/or channel state information (CSI). As mentioned above, the alternate access point could use such information to determine the alternate access point's beamforming weights.

The rerouting command can include a downlink or uplink resource allocation message or any other control message. Other implementations of the rerouting command are also possible.

A method can also include, at 1090, receiving a rerouting command intended for a user equipment, at an access point. The rerouting command can include information about a radio link between the user equipment and the alternate access point. The information can include link quality, best beam, channel state information, or any combination thereof. The rerouting command can include a downlink control channel information of an alternate access point over which the alternate access point is to transmit the handoff command to the user equipment.

The method can further include, at 1095, subsequently transmitting a handoff command to the intended user equipment. The handoff command can include downlink/uplink resource allocation or other downlink control message. The handoff message transmission can be beamformed.

The receiving at 1090 and the transmitting at 1095 can be performed by the alternate access point. Thus, the combination of features illustrated in FIG. 10 can be performed by a combination of different network elements operating together.

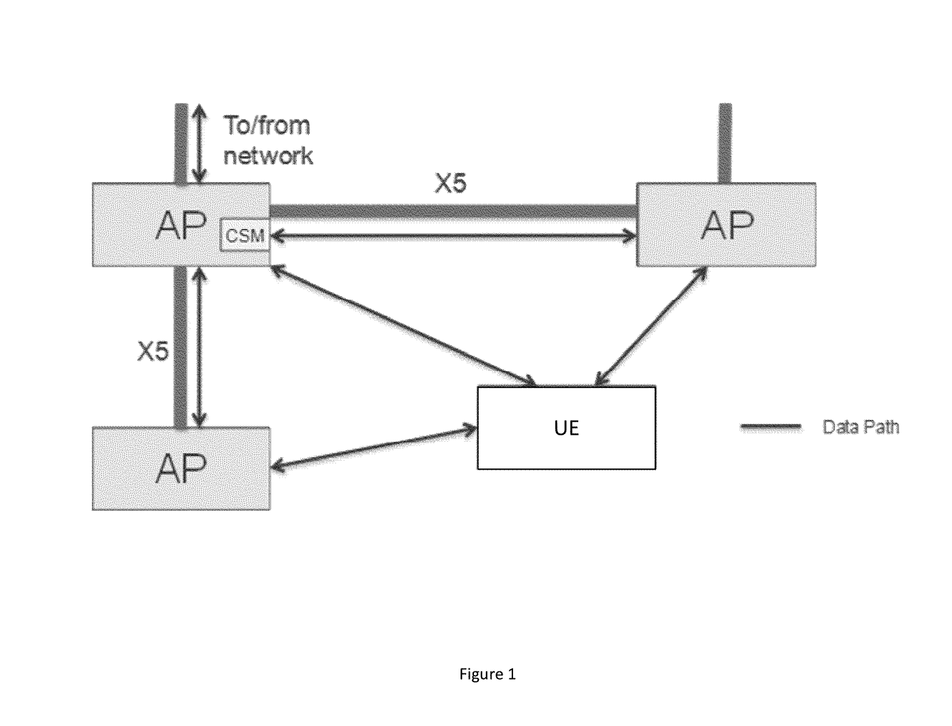

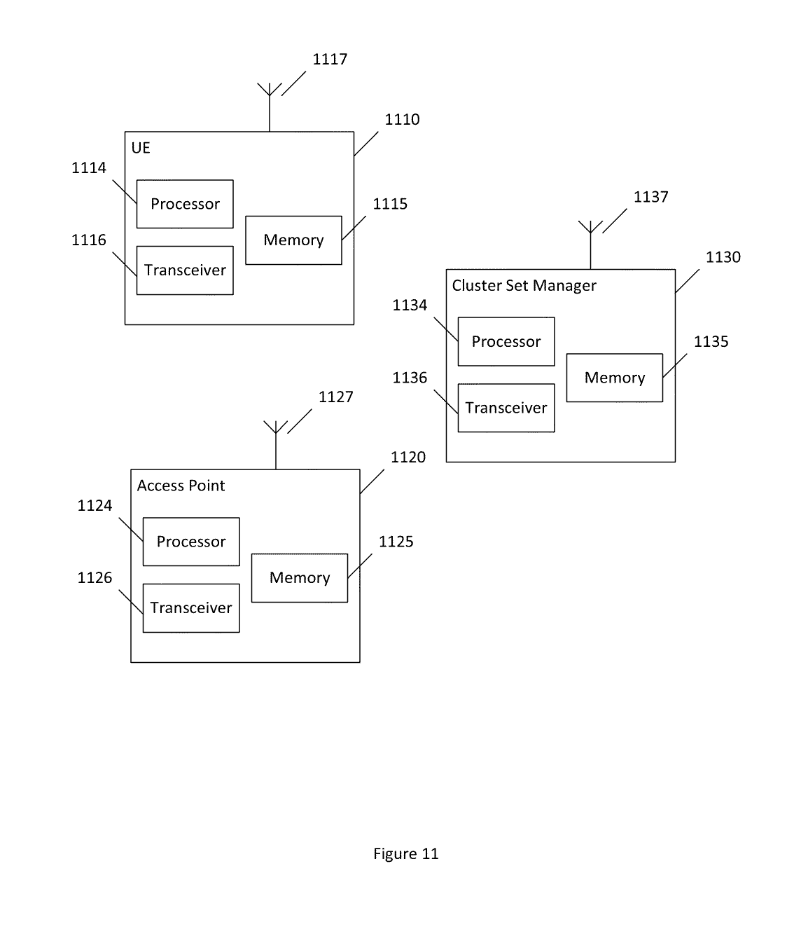

FIG. 11 illustrates a system according to certain embodiments of the invention. In one embodiment, a system may include multiple devices, such as, for example, at least one UE 1110, at least one cluster of access points, of which one access point 1120 is shown, which may be an eNB, RAGS, RNC, or other base station or access point, and at least one cluster set manager 1130. The cluster set manager 1130 is shown as a separate device from the access point 1120, but may be incorporated into one or more access point in certain embodiments (see, for example, FIG. 1).

The UE 1110 can be any terminal equipment, such as a mobile phone, a smart phone, a laptop or tablet computer, a personal computer, a vehicle computer, a smart meter, a communications equipped sensor, or any other device. It is not required that the UE 1110 be mobile, although certain embodiments may be beneficial for devices that are mobile and consequently experience changing channel conditions.

In certain embodiments, both UE 1110 and access point 1120 may be equipped to communicate with one another using millimeter wave communications.

As shown in FIG. 11, each of these devices may include at least one processor, respectively indicated as 1114, 1124, and 1134. At least one memory can be provided in each device, and indicated as 1115, 1125, and 1135, respectively. The memory may include computer program instructions or computer code contained therein. The processors 1114, 1124, and 1134 and memories 1115, 1125, and 1135, or a subset thereof, can be configured to provide means corresponding to the various blocks of FIG. 10.

As shown in FIG. 11, transceivers 1116, 1126, and 1136 can be provided, and each device may also include an antenna, respectively illustrated as 1117, 1127, and 1137. Other configurations of these devices, for example, may be provided. For example, cluster set manager 1130 may be configured for wired communication, in addition to or instead of wireless communication, and in such a case antenna 1137 can illustrate any form of communication hardware, without requiring a conventional antenna. In certain embodiments, as mentioned above, the cluster set manager 1130 may be running on the same hardware. Alternatively, the cluster set manager 1130 may run on a separate blade of a multi-blade computing system that also provides the access point 1120. Other embodiments are also possible.

Transceivers 1116, 1126, and 1136 can each, independently, be a transmitter, a receiver, or both a transmitter and a receiver, or a unit or device that is configured both for transmission and reception. Although only one transceiver is shown per device, each device may include multiple radios.

Processors 1114, 1124, and 1134 can be embodied by any computational or data processing device, such as a central processing unit (CPU), application specific integrated circuit (ASIC), or comparable device. The processors can be implemented as a single controller, or a plurality of controllers or processors.

Memories 1115, 1125, and 1135 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as UE 1110, access point 1120, and cluster set manager 1130, to perform any of the processes described herein (see, for example, FIG. 10). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 11 illustrates a system including a UE, access point, and cluster set manager, embodiments of the invention may be applicable to other configurations, and configurations involving additional elements. For example, not shown, additional UEs and APs may be present, and core network elements may be present.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

List of Abbreviations

mmWave Millimeter wave

UE User Equipment

AP Access point

TDD Time division duplex

DL Downlink

UL Uplink

CSM Cluster Set Manager

CSI Channel State Information

SINR Signal-to-Interference and Noise Ratio

DTX Discontinuous Transmission

We claim:

1. A method, comprising:
transmitting, from an access point, a downlink control message to a user equipment;
attempting to detect a Fast-ACK transmission signal from the user equipment in response to the transmitted downlink control message; and
transmitting a rerouting request for the user equipment when the Fast-ACK transmission signal is not detected.

2. The method of claim 1, wherein the transmitting the rerouting request comprises transmitting the request to a cluster set manager (CSM) configured to control routing of messages to the user equipment.

3. The method of claim 1, wherein the downlink control message comprises at least one of a downlink resource allocation message or a uplink resource allocation message.

4. The method of claim 1, wherein the transmitting the downlink control message comprises transmitting the downlink control message using beamforming.

5. The method of claim 1, wherein the attempting to detect the Fast-ACK transmission signal comprises receiving using beamforming.

6. The method of claim 1, wherein the Fast-ACK transmission signal comprises information about a radio link between the user equipment and an alternate access point.

7. The method of claim 6, wherein the information comprises link quality, best beam, and/or channel state information.

8. The method of claim 1, wherein transmitting the rerouting request for the user equipment comprise transmitting link quality information between the user equipment and an alternate access point.

9. A method, comprising:
receiving, at a user equipment from an access point, a downlink control message over a downlink control channel; and
replying to the downlink control message with a Fast-ACK transmission signal over a Fast-ACK channel.

10. The method of claim 9, wherein the replying is contingent on successfully decoding the downlink control message.

11. The method of claim 9, wherein the receiving the downlink control message comprises using beamforming.

12. The method of claim 9, wherein the replying with the Fast-ACK transmission signal comprises using beamforming.

13. The method of claim 9, further comprising:
receiving a second downlink control channel from at least one other access point.

14. The method of claim 13, wherein the downlink control channel and the second downlink control channel are time-multiplexed and are received using beamformed receivers.

15. The method of claim 13, wherein the downlink control channel and the second downlink control channel are received simultaneously using an omni-directional receiver.

16. The method of claim 9, wherein the Fast-ACK transmission signal comprises information about a radio link between the user equipment and an alternate access point.

17. The method of claim 16, wherein the information comprises at least one of signal to interference plus noise ratio, channel state information, preferred beam, preferred access point or access point measurement reports, rank-ordered list of alternative access points, or best beam of a best alternative access point.

18. A method, comprising:
receiving, from an access point, a rerouting request for a user equipment; and
sending, to an alternate access point, a rerouting command responsive to the rerouting request for the user equipment.

19. The method of claim 18, wherein the rerouting command comprises information about a radio link between the user equipment the alternate access point.

20. The method of claim 19, wherein the information comprises link quality, best beam, and/or channel state information.

21. The method of claim 18, wherein the rerouting command comprises at least one of a downlink resource allocation message or an uplink resource allocation message or any other downlink control message.

22. The method of claim 18, wherein the receiving the rerouting request comprises receiving link quality information between the user equipment and the alternate access point.

23. The method of claim 18, wherein the rerouting command comprises a downlink control channel information of the alternate access point.

24. An apparatus, comprising:
at least one processor; and
at least one memory including computer program code,
wherein the at least one memory and computer program code are configured to, with the at least one processor, cause the apparatus at least to
transmit, from an access point, a downlink control message to a user equipment;
attempt to detect a Fast-ACK transmission signal from the user equipment in response to the transmitted downlink control message; and
transmit a rerouting request for the user equipment when the Fast-ACK transmission signal is not detected.

25. The apparatus of claim 24, wherein the at least one memory and computer program code are configured to, with the at least one processor, cause the apparatus at least to transmit the rerouting request to a cluster set manager (CSM) configured to control routing of messages to the user equipment.

26. The apparatus of claim 24, wherein the downlink control message comprises at least one of a downlink resource allocation message or a uplink resource allocation message or any other downlink control message.

27. The apparatus of claim 24, wherein the at least one memory and computer program code are configured to, with the at least one processor, cause the apparatus at least to transmit the downlink control message using beamforming.

28. The apparatus of claim 24, wherein the at least one memory and computer program code are configured to, with the at least one processor, cause the apparatus at least to attempt to detect the Fast-ACK transmission signal using beamforming.

29. The apparatus of claim 24, wherein the Fast-ACK transmission signal comprises information about a radio link between the user equipment and an alternate access point.

30. The apparatus of claim 29, wherein the information comprises link quality, best beam, and/or channel state information.

31. The method of claim 24, wherein transmission of the rerouting request for the user equipment comprise transmitting link quality information between the user equipment and an alternate access point.

32. An apparatus, comprising:
at least one processor; and
at least one memory including computer program code,
wherein the at least one memory and computer program code are configured to, with the at least one processor, cause the apparatus at least to
receive, at a user equipment from an access point, a downlink control message over a downlink control channel; and
reply to the downlink control message with a Fast-ACK transmission signal over a Fast-ACK channel.

33. The apparatus of claim 32, wherein the at least one memory and computer program code are configured to, with the at least one processor, cause the apparatus at least to reply to the downlink control message contingent on successfully decoding the downlink control message.

34. The apparatus of claim 32, wherein the receiving the downlink control message comprises using beamforming.

35. The apparatus of claim 32, wherein the replying with the Fast-ACK transmission signal comprises using beamforming.

36. The apparatus of claim 32, wherein the at least one memory and computer program code are configured to, with the at least one processor, cause the apparatus at least to receive a second downlink control channel from at least one other access point.

37. The apparatus of claim 36, wherein the downlink control channel and the second downlink control channel are time-multiplexed and are received using beamformed receivers.

38. The apparatus of claim 36, wherein the downlink control channel and the second downlink control channel are received simultaneously using an omni-directional receiver.

39. The apparatus of claim 32, wherein the Fast-ACK transmission signal comprises information about a radio link between the user equipment and an alternate access point.

40. The apparatus of claim 39, wherein the information comprises at least one of signal to interference plus noise ratio, channel state information, preferred beam, preferred access point or access point measurement reports, rank-ordered list of alternative access points, or best beam of a best alternative access point.

41. An apparatus, comprising:
at least one processor; and
at least one memory including computer program code,
wherein the at least one memory and computer program code are configured to, with the at least one processor, cause the apparatus at least to
receive, from an access point, a rerouting request for a user equipment; and
send, to an alternate access point, a rerouting command responsive to the rerouting request for the user equipment.

42. The apparatus of claim 41, wherein the rerouting command comprises information about a radio link between the user equipment and the alternate access point.

43. The apparatus of claim 42, wherein the information comprises link quality, best beam, and/or channel state information.

44. The apparatus of claim 41, wherein the rerouting command comprises at least one of a downlink resource allocation message or an uplink resource allocation message or any other downlink control message.

45. The apparatus of claim 41, wherein reception of the rerouting request comprises receiving link quality information between the user equipment and the alternate access point.

46. The apparatus of claim 41, wherein the rerouting command comprises a downlink control channel information of the alternate access point.

47. A method, comprising:
receiving a rerouting command intended for a user equipment, at an access point; and
subsequently transmitting a handoff command to the intended user equipment.

48. The method of claim 47, wherein the rerouting command comprises information about a radio link between the user equipment and the alternate access point.

49. The method of claim 48, wherein the information comprises link quality, best beam, and/or channel state information.

50. The method of claim 47, where the rerouting command comprises a downlink control channel information of an alternate access point over which the alternate access point is to transmit the handoff command to the user equipment.

51. The method of claim 47, wherein the handoff command includes downlink/uplink resource allocation or other downlink control message

52. The method of claim 47, wherein the handoff message transmission is beamformed.

53. An apparatus, comprising:
at least one processor; and
at least one memory including computer program code,
wherein the at least one memory and computer program code are configured to, with the at least one processor, cause the apparatus at least to
receive a rerouting command intended for a user equipment, at an access point; and
subsequently transmit a handoff command to the intended user equipment.

54. The apparatus of claim 53, wherein the rerouting command comprises information about a radio link between the user equipment and the alternate access point.

55. The apparatus of claim 54, wherein the information comprises link quality, best beam, and/or channel state information.

56. The apparatus of claim 53, where the rerouting command comprises a downlink control channel information of an alternate access point over which the alternate access point is to transmit the handoff command to the user equipment.

57. The apparatus of claim 53, wherein the handoff command includes downlink/uplink resource allocation or other downlink control message

58. The apparatus of claim 53, wherein the handoff message transmission is beamformed.
